(19) United States
(12) Patent Application Publication
(10) Pub. No.: US 2018/0057675 A1
(43) Pub. Date: Mar. 1, 2018

(54) Rubber Composition, and Pneumatic Tire Using Same

(71) Applicant: The Yokohama Rubber Co., LTD., Minato-ku, Tokyo (JP)

(72) Inventors: Ryutaro Nakagawa, Hiratsuka-shi, Kanagawa (JP); Yusuke Tanabe, Hiratsuka-shi, Kanagawa (JP)

(21) Appl. No.: 15/556,288

(22) PCT Filed: Mar. 3, 2016
(86) PCT No.: PCT/JP2016/056624

§ 371 Date: Sep. 6, 2017

(30) Foreign Application Priority Data
Mar. 6, 2015 (JP) 2015-044998

(51) Int. Cl. C08L 23/26; C08L 77/00; C08L 9/00; C08K 3/00; B60C 1/00

(52) U.S. Cl. CPC C08L 23/26; C08L 77/00; B60C 1/00; C08K 3/0033; C08L 9/00

(57) ABSTRACT

The present technology provides a rubber composition including: a diene rubber; at least one type selected from the group consisting of carbon black and a white filler; an acid-modified polyolefin; and a polyamide polyether elastomer. The content of the at least one type selected from the group consisting of carbon black and a white filler is from 1 to 100 parts by mass per 100 parts by mass of the diene rubber. The total content of the acid-modified polyolefin and the polyamide polyether elastomer is from 3 to 35 parts by mass per 100 parts by mass of the diene rubber. The present technology also provides a pneumatic tire which uses the rubber composition.

### TECHNICAL FIELD

The present technology relates to a rubber composition and a pneumatic tire using the same.

### BACKGROUND ART

Conventionally, to provide a rubber composition exhibiting low heat build-up or the like, a rubber composition in which a polyamide polyether elastomer is blended to a diene rubber has been proposed (e.g. Japanese Unexamined Patent Application Publication No. 2011-246685).

In such circumstances, when a rubber composition including a diene rubber and a polyamide polyether elastomer was prepared based on Japanese Unexamined Patent Application Publication No. 2011-246685 and was evaluated, it was found that such a rubber composition exhibited a significantly deteriorated permanent set (Comparative Example 4).

Furthermore, because demands for even better physical properties such as modulus for rubber composition are increasing in recent years, further enhancement in modulus was required to achieve such demands (Comparative Examples 2, 4, and 6).

When the inventors of the present technology prepared a rubber composition by blending an acid-modified polyolefin to a diene rubber and a polyamide polyether elastomer to improve the modulus and evaluated the rubber composition, it was found that such a rubber composition may not be appropriately produced because the processability thereof was found to be deteriorated (Comparative Example 7).

Furthermore, an increase in the content of the acid-modified polyolefin in the rubber composition may deteriorate the low heat build-up characteristics. (Comparative Example 5).

### SUMMARY

The present technology provides a rubber composition that exhibits an excellent modulus and processability and that can reduce permanent set, while a high elongation at break and excellent low heat build-up are maintained; and to provide a pneumatic tire using the same.

As a result of diligent research, the inventors of the present technology found that a composition can achieve predetermined effects by including a diene rubber, at least one type selected from the group consisting of carbon black and a white filler, an acid-modified polyolefin, and a polyamide polyether elastomer, and by setting the content of the at least one type selected from the group consisting of carbon black and a white filler and the total content of the acid-modified polyolefin and the polyamide polyether elastomer to predetermined ranges, and thus completed the present technology.

The present technology is based on the findings described above by the following features.

1. A rubber composition including: a diene rubber, at least one type selected from the group consisting of carbon black and a white filler, an acid-modified polyolefin, and a polyamide polyether elastomer;

a content of the at least one type selected from the group consisting of carbon black and a white filler being from 1 to 100 parts by mass per 100 parts by mass of the diene rubber; and

a total content of the acid-modified polyolefin and the polyamide polyether elastomer being from 3 to 35 parts by mass per 100 parts by mass of the diene rubber.

2. The rubber composition according to 1 above, where a content of the acid-modified polyolefin in the total content is from 2 to 30 parts by mass.

3. The rubber composition according to 1 or 2 above, where the rubber composition is obtained by mixing the diene rubber, the at least one type selected from the group consisting of carbon black and a white filler, the acid-modified polyolefin, and the polyamide polyether elastomer at a temperature equal to or higher than a melting point of the acid-modified polyolefin and equal to or higher than a melting point of the polyamide polyether elastomer.

4. A pneumatic tire including the rubber composition described in any one of 1 to 3 above.

The rubber composition of the present technology and the pneumatic tire of the present technology can exhibit an excellent modulus and processability and can reduce permanent set while a high elongation at break and excellent low heat build-up are maintained.

### BRIEF DESCRIPTION OF DRAWINGS

FIG. 1 is a partial cross-sectional schematic view of a tire that illustrates one embodiment of a pneumatic tire of the present technology.

### DETAILED DESCRIPTION

Embodiments of the present technology are described in detail below.

Note that, in the present specification, numerical ranges indicated using “(from) . . . to . . . ” include the former number as the lower limit value and the later number as the upper limit value.

Furthermore, in the present specification, when a component includes two or more types of substances, the content of the component refers to the total content of the two or more types of substances.

The rubber composition of the present technology is

a rubber composition including: a diene rubber, at least one type selected from the group consisting of carbon black and a white filler, an acid-modified polyolefin, and a polyamide polyether elastomer;

a content of the at least one type selected from the group consisting of carbon black and a white filler being from 1 to 100 parts by mass per 100 parts by mass of the diene rubber; and

a total content of the acid-modified polyolefin and the polyamide polyether elastomer being from 3 to 35 parts by mass per 100 parts by mass of the diene rubber.

The rubber composition of the present technology is thought to achieve desired effects as a result of having such a configuration. Although the reason for this is unknown, the reason is presumed to be as follows.

The inventors of the present technology surmise that, by allowing the amino group included in the polyamide polyether elastomer and the acid moiety of the acid-modified polyolefin to interact each other, dispersibility in rubber may be enhanced. Thus, domain sizes of the polyamide polyether elastomer and the acid-modified polyolefin in the rubber as a matrix may become smaller, leading to enhancement in processability, reduction in permanent set, and the like.

### Rubber Composition

Each of the components included in the rubber composition of the present technology will be described in detail below.

### Diene Rubber

The diene rubber included in the rubber composition of the present technology is not particularly limited as long as the diene rubber has a double bond in the main chain. Examples of the diene rubber include natural rubber (NR), isoprene rubber (IR), butadiene rubber (BR), aromatic vinyl-conjugated diene copolymer rubber (e.g. styrene butadiene rubber (SBR)), chloroprene rubber (CR), acrylonitrile butadiene rubber (NBR), ethylene-propylene-diene copolymer rubber (EPDM), styrene-isoprene rubber, isoprene-butadiene rubber, nitrile rubber, and hydrogenated nitrile rubber.

A single type of diene rubber can be used, or a combination of two or more types of diene rubbers can be used.

Among these, NR and BR are preferred.

Although the weight average molecular weight of the diene rubber is not particularly limited, from the perspective of processability, the weight average molecular weight is preferably from 50000 to 3000000, and more preferably from 100000 to 2000000. Note that the weight average molecular weight (Mw) of the diene rubber is a value based on a measured value obtained by gel permeation chromatography (GPC) using tetrahydrofuran as a solvent, determined based on calibration with polystyrene standard.

When the diene rubber includes at least one type selected from the group consisting of NR and BR, the content of the at least one type selected from the group consisting of NR and BR is preferably from 10 to 100 mass % relative to the amount of the diene rubber from the perspectives of even better low heat build-up and excellent tensile properties.

When the diene rubber includes NR and BR, the proportion of the content of the BR relative to the content of the NR (BR/NR) is preferably from 25 to 300 mass %.

### Carbon Black

Examples of the carbon black that may be included in the rubber composition of the present technology include those similar to carbon blacks that can be generally used in rubber compositions. Specific examples thereof include SAF (Super Abrasion Furnace), ISAF (Intermediate Super Abrasion Furnace), IISAF, N339, HAF (High Abrasion Furnace), FEF (Fast Extrusion Furnace), GPE (General Purpose Furnace), and SRF (Semi-Reinforcing Furnace). Among these, SAF, ISAF, IISAF, N339, HAF, and FEF are preferred.

The nitrogen adsorption specific surface area (N₂SA) of the carbon black is preferably from 30 to 250 m²/g, and more preferably from 40 to 240 m²/g, from the perspective of even better processability of the rubber composition.

Note that the N₂SA is a value of the amount of nitrogen adsorbed to a surface of carbon black, measured in accordance with JIS (Japanese Industrial Standard) K6217-2:2001, “Part 2: Determination of specific surface area—Nitrogen adsorption methods—Single-point procedures”.

A single type of carbon black can be used alone, or a combination of two or more types of carbon blacks can be used.

### White Filler

Examples of the white filler that may be included in the rubber composition of the present technology include those similar to white fillers that can be generally used in rubber compositions. Specific examples thereof include silica, calcium carbonate, talc, and clay. Among these, silica is preferred.

Examples of the silica include fumed silica, calcined silica, precipitated silica, pulverized silica, molten silica, and colloidal silica.

The silica preferably has the CTAB (cetyltrimethylammonium bromide) adsorption specific surface area of 50 to 300 m²/g, and more preferably from 80 to 250 m²/g, from the perspective of suppressing aggregation of the silica.

Note that the CTAB adsorption specific surface area is a value of the amount of n-hexadecyltrimethylammonium bromide adsorbed to the surface of silica measured in accordance with JIS K6217-3:2001 “Part 3: Method for determining specific surface area—CTAB adsorption method.”

A single type of white filler can be used, or a combination of two or more types of white fillers can be used.

An example of a preferable aspect is one in which the rubber composition of the present technology includes carbon black.

In the present technology, the content of the at least one type selected from the group consisting of carbon black and a white filler is from 1 to 100 parts by mass, preferably from 5 to 95 parts by mass, and more preferably from 10 to 90 parts by mass, per 100 parts by mass of the diene rubber.

Note that, when the rubber composition of the present technology includes carbon black and a white filler, the content described above is the total content of the carbon black and the white filler.

### Acid-Modified Polyolefin

The acid-modified polyolefin included in the rubber composition of the present technology is a polyolefin that is modified with carboxylic acid.

The backbone of the acid-modified polyolefin may be a homopolymer or a copolymer.

An example of a preferable aspect is one in which the main chain of the acid-modified polyolefin is a polyolefin having repeating units formed from an olefin. Examples of the olefin include ethylene; and α-olefins, such as propylene, 1-butene, and 1-octene.

### Polyolefin

Examples of the polyolefin constituting the backbone (main chain) of the acid-modified polyolefin include homopolymers of polyethylene, polypropylene, polybutene, polyoctane, or the like; and copolymers formed from at least two types of olefins.

Among these, homopolymers are preferred, and polypropylene and polyethylene are more preferred.

Examples of the polyethylene include low density to high density polyethylenes. Among these, a high density polyethylene is preferred. When the main chain of the acid-modified polyolefin is a high density polyethylene, the density of the acid-modified polyolefin is preferably from 940 to 980 kg/m³. Note that the density of the acid-modified polyolefin in the present technology was measured in accordance with ASTM D1505.

### Carboxylic Acid

Meanwhile, examples of the carboxylic acid that modifies the polyolefin described above include unsaturated carboxylic acid. Specific examples thereof include monocarboxylic acids, such as acrylic acid and methacrylic acid; dicarboxylic acids, such as maleic acid, fumaric acid, crotonic acid, and itaconic acid; and acid anhydrides. Examples of the acid anhydride include anhydride of dicarboxylic acid.

Among these, maleic anhydride, maleic acid, and acrylic acid are preferred.

As the acid-modified polyolefin is preferably a polyolefin modified with an acid anhydride, and is more preferably a polyolefin modified with maleic anhydride.

In the acid-modified polyolefin, the position in the main chain, at which the carboxylic acid is bonded, is not particularly limited. Examples thereof include terminals and side chains. In particular, the carboxylic acid is preferably bonded to the main chain as a side chain. The carboxylic acid and the main chain may be directly bonded or bonded via an organic group. The organic group is not particularly limited.

An example of a preferable aspect is one in which the acid-modified polyolefin is solid at 23° C.

From the perspectives of even better modulus and processability, the melting point of the acid-modified polyolefin is preferably from 105 to 146° C., and more preferably from 110 to 145° C.

The melting point of the acid-modified polyolefin in the present technology was measured in accordance with ASTM D2117.

The production method of the acid-modified polyolefin is not particularly limited. Examples thereof include conventionally known production methods. An example of a preferable aspect is a production method by graft polymerization.

Furthermore, a commercially available product of the acid-modified polyolefin can be used.

Examples of the commercially available product include maleic anhydride-modified polypropylenes, such as Admer QE060 (manufactured by Mitsui Chemicals, Inc.); and maleic anhydride-modified high density polyethylenes, such as Admer HE810 (manufactured by Mitsui Chemicals, Inc.).

A single type of acid-modified polyolefin can be used alone, or a combination of two or more types of acid-modified polyolefins can be used.

### Polyamide Polyether Elastomer

The polyamide polyether elastomer included in the rubber composition of the present technology is a block copolymer having a polyamide as a hard segment and a polyether as a soft segment.

An example of a preferable aspect is one in which the polyamide polyether elastomer includes a polyamide and a polyether, and the polyamide and the polyether are bonded by amide bonding.

Examples of the polyamide polyether elastomer include those having a structure represented by Formula (1) below.

—[—CO-PA-CO-NH-PE-NH-]ₙ— (1)

In the formula, PA is a polyamide, PE is a polyether, n is 1 or 2 or greater. The upper limit of n can be appropriately selected depending on the weight average molecular weight of the polyamide polyether elastomer. The upper limit of n can be set to 500 or less.

The polyamide that can constitute the PA above include polyamide 6, polyamide 66, polyamide 610, polyamide 11, and polyamide 12 (nylon 12). Among these, polyamide 12 is preferred.

The polyether that can constitute the PE above include polyoxyalkylene polyols. Specific examples thereof include polyoxytetramethylene diol and polyoxypropylene diol.

The melting point of the polyamide polyether elastomer is preferably from 70 to 160° C., and more preferably from 90 to 150° C.

The melting point of the polyamide polyether elastomer was measured in a nitrogen atmosphere using a differential scanning calorimeter DSC-50, manufactured by Shimadzu Corporation. The temperature was increased from the room temperature to 230° C. at a rate of 10° C./min (referred to as “heating-first run”), maintained at 230° C. for 10 minutes, then decreased to −100° C. at a rate of 10° C./min (referred to as “cooling-first run”), and then increased to 230° C. at a rate of 10° C./min (referred to as “heating-second run”). From the obtained DSC chart, the exothermic peak temperature of the cooling-first run is used as a crystallization temperature (Tc), and the endothermic peak temperature of the heating-second run is used as the melting point (Tm).

The production method of the polyamide polyether elastomer is not particularly limited. Examples thereof include conventionally known production methods.

A commercially available product of polyamide polyether elastomer can be used. Examples of the commercially available product of the polyamide polyether elastomer include XPA, manufactured by Ube Industries, Ltd.

A single type of polyamide polyether elastomer can be used alone, or a combination of two or more types of polyamide polyether elastomers can be used.

In the present technology, the total content of the acid-modified polyolefin and the polyamide polyether elastomer (hereinafter, “total content of the acid-modified polyolefin and the polyamide polyether elastomer” may be simply referred to as “total content”) is from 3 to 35 parts by mass per 100 parts by mass of the diene rubber.

From the perspective of achieving even higher modulus, the total content is preferably from 5 to 33 parts by mass, and more preferably from 10 to 30 parts by mass, per 100 parts by mass of the diene rubber.

From the perspectives of achieving even better low heat build-up and even smaller permanent set, the total content is preferably from 4 to 30 parts by mass, and more preferably from 5 to 25 parts by mass, per 100 parts by mass of the diene rubber.

The content of the acid-modified polyolefin in the total content is preferably from 2 to 30 parts by mass, and more preferably from 5 to 25 parts by mass.

The content of the polyamide polyether elastomer is preferably 75 mass % or less, and more preferably from 60 to 20 mass %, relative to the total content.

### Additives

The rubber composition of the present technology may further include an additive as necessary in a range that does not inhibit the effect. Examples of the additives include those that can be ordinarily blended to a rubber composition, such as vulcanizing agents, cross-linking agents, vulcanization accelerators, zinc oxide, vulcanization accelerator aids such as stearic acid, vulcanization retarders, oils, anti-aging agents, and plasticizers. The content of the additive may be selected as desired.

An example of a preferable aspect is one in which the rubber composition of the present technology includes substantially no recycled polyethylene terephthalate. Examples of such recycled polyethylene terephthalate include powder obtained by micronizing unused or used molded products formed from polyethylene terephthalate. “Including substantially no recycled polyethylene terephthalate” refers to the condition where the content of the recycled polyethylene terephthalate is from 0 to 0.1 parts by mass per 100 parts by mass of the entire rubber composition of the present technology. The content of the recycled polyethylene terephthalate relative to the entire rubber composition of the present technology is preferably 0 parts by mass.

Examples of the method of producing the rubber composition of the present technology include a method in which the diene rubber, the at least one type selected from the group consisting of carbon black and a white filler, the acid-modified polyolefin, and the polyamide polyether elastomer are mixed at a temperature equal to or higher than a melting point of the acid-modified polyolefin and equal to or higher than a melting point of the polyamide polyether elastomer.

An additive that may be used as necessary may be further added to the components described above.

Furthermore, components other than the vulcanization components, such as vulcanizing agents and vulcanization accelerators, may be mixed in advance and then vulcanization components may be added thereto. At this time, when mixing is performed during the premixing or after the vulcanization components are added, the mixing can be performed at a temperature equal to or higher than the melting point of the acid-modified polyolefin and equal to or higher than the melting point of the polyamide polyether elastomer.

The temperature at which the components described above is mixed is preferably a temperature equal to or higher than the melting point of the acid-modified polyolefin and equal to or higher than the melting point of the polyamide polyether elastomer. Specifically, an example thereof is from 50 to 170° C.

The apparatus used during the mixing of the components is not particularly limited. Examples thereof include conventionally known apparatus.

In the present specification, mixing include kneading.

The rubber composition of the present technology can be, for example, vulcanized or crosslinked under conventionally known vulcanization or crosslinking conditions.

The rubber composition of the present technology can be used as a rubber composition used for, for example, producing pneumatic tires or conveyor belts.

### Pneumatic Tire

The pneumatic tire of the present technology is a pneumatic tire that is produced by using the rubber composition of the present technology described above. The rubber composition of the present technology can be used for, for example, tire treads, sidewalls, and bead fillers of pneumatic tires.

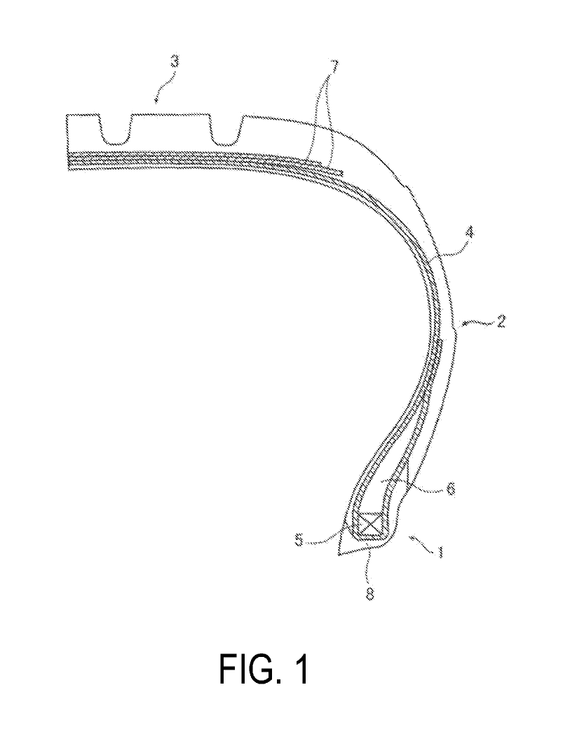

FIG. 1 is a partial cross-sectional schematic view of a tire that illustrates one embodiment of a pneumatic tire of the present technology. Note that the present technology is not limited to the attached drawings.

In FIG. 1, reference sign 1 denotes a bead portion, reference sign 2 denotes a sidewall portion, and reference sign 3 denotes a tire tread portion. A carcass layer 4, in which fiber cords are embedded, is mounted between a left-right pair of the bead portions 1, and ends of the carcass layer 4 are turned up around bead cores 5 and bead fillers 6 from an inner side to an outer side of the tire. In the tire tread portion 3, a belt layer 7 is provided along the entire periphery of the tire on the outer side of the carcass layer 4. Rim cushions 8 are provided in parts of the bead portions 1 that are in contact with a rim (not illustrated).

The pneumatic tire of the present technology can be produced, for example, in accordance with a conventionally known method. In addition to ordinary air or air with an adjusted oxygen partial pressure, inert gases such as nitrogen, argon, and helium can be used as the gas with which the tire is filled.

### EXAMPLES

The present technology is described below in detail using examples. However, the present technology is not limited to such examples.

### Method of Producing Rubber Composition

The components shown in Table 1 to Table 4 below were used in the composition (part by mass) shown in the same tables.

Among the components shown in tables below, the components except the vulcanizing components (sulfur, vulcanization accelerator) were kneaded for total of approximately 4 minutes including approximately 2 minutes of kneading using a tangential mixer in a condition at 160° C. The vulcanization components were added to the mixture obtained as described below, and these were kneaded using an open roll in a condition at 10 to 100° C. to produce a rubber sheet.

### Evaluation of Processability of Rubber Composition

The processability of the rubber composition was evaluated by winding around an open roll and by the condition of finish of the rubber sheet. The results are shown in Tables 1 to 4.

When the rubber composition exhibited excellent winding around an open roll and the rubber sheet produced as described above did not have roughness and edge break, the processability was evaluated as excellent and shown as “A”.

When the rubber composition exhibited poor winding around an open roll or the rubber sheet produced as described above had roughness or edge break, the processability was evaluated as poor and shown as “B”.

### Vulcanization of Rubber Composition

The rubber sheet produced as described above was subjected to press vulcanization in a predetermined mold at 160° C. for 15 minutes to prepare a vulcanized rubber test piece (thickness: 2 mm).

### Evaluation of Vulcanized Rubber Test Piece

For the vulcanized rubber test piece prepared as described above, the following physical properties were measured using the following test methods. The results are shown in Tables 1 to 4.

### M100

A JIS No. 3 dumbbell-shaped test piece was punched out from the vulcanized rubber test piece produced as described above, and a tensile test was performed at a tensile test speed of 500 mm/min in accordance with JIS K6251:2010 to measure the tensile stress at 100% elongation (100% modulus: M100) in a condition at 20° C.

The evaluation result of M100 of each example is shown as an index value with Reference Example expressed as an index value of 100.

A larger index value indicates superior M100.

### Elongation at Break

A JIS No. 3 dumbbell-shaped test piece was punched out from the vulcanized rubber test piece produced as described above, and a tensile test was performed at a tensile test speed of 500 mm/min in accordance with JIS K6251:2010 to measure the elongation at break (Eb).

The evaluation result of elongation at break of each example is shown as an index value with Reference Example expressed as an index value of 100.

A larger index value indicates superior elongation at break.

### tan δ (60° C.)

The value of tan δ (60° C.) of the vulcanized rubber test piece produced as described above was measured using a viscoelastic spectrometer manufactured by Iwamoto Seisakusho at an elongation deformation distortion factor of 10±2%, a vibration frequency of 20 Hz, and a temperature of 60° C.

The evaluation result of tan δ (60° C.) of each example is shown as an index value with Reference Example expressed as an index value of 100.

A smaller index value indicates superior low heat build-up.

### Permanent Set

For the vulcanized rubber test piece prepared as described above, the compression set at 20° C. after 25% compression at 70° C. for 22 hours was measured in accordance with JIS K6262:2013.

The evaluation result of compression set of each example is shown as an index value with Reference Example expressed as an index value of 100.

A smaller index value indicates smaller permanent set, which is preferable.

TABLE 1

| Composition | | | | | | |
|---|---|---|---|---|---|---|
| [component/ | | Comparative | | | | |
| compounded amount | Reference | Example | | Example | | |
| (part by mass)] | Example | 1 | 2 | 1 | 2 | 3 |
| NR | 40 | 40 | 40 | 40 | 40 | 40 |
| BR | 60 | 60 | 60 | 60 | 60 | 60 |
| Acid-modified | | 8 | | 6 | 4 | 2 |
| polyolefin 1 | | | | | | |
| Polyamide polyether | | | 8 | 2 | 4 | 6 |
| elastomer | | | | | | |
| Carbon black | 50 | 50 | 50 | 50 | 49 | 48 |
| Zinc oxide | 3 | 3 | 3 | 3 | 3 | 3 |
| Stearic acid | 1.5 | 1.5 | 1.5 | 1.5 | 1.5 | 1.5 |
| Anti-aging agent | 3.25 | 3.25 | 3.25 | 3.25 | 3.25 | 3.25 |
| (S-13) | | | | | | |
| Wax | 1 | 1 | 1 | 1 | 1 | 1 |
| Oil | 12 | 12 | 12 | 12 | 12 | 12 |
| Sulfur | 1.54 | 1.54 | 1.54 | 1.54 | 1.54 | 1.54 |
| Vulcanization | 0.8 | 0.8 | 0.8 | 0.8 | 0.8 | 0.8 |
| accelerator (CZ) | | | | | | |
| Processability of | A | A | A | A | A | A |
| rubber composition | | | | | | |
| M100 | 100 | 135 | 104 | 150 | 143 | 138 |
| Elongation at break | 100 | 91 | 97 | 100 | 100 | 102 |
| tan δ (60° C.) | 100 | 100 | 98 | 100 | 98 | 95 |
| Permanent set | 100 | 111 | 102 | 101 | 101 | 92 |

TABLE 2

| Composition | | | | | | |
|---|---|---|---|---|---|---|
| [component/ | | Comparative | | | | |
| compounded amount | Reference | Example | | Example | | |
| (part by mass)] | Example | 3 | 4 | 4 | 5 | 6 |
| NR | 40 | 40 | 40 | 40 | 40 | 40 |
| BR | 60 | 60 | 60 | 60 | 60 | 60 |
| Acid-modified | | 15 | | 10 | 7.5 | 5 |
| polyolefin 1 | | | | | | |
| Polyamide polyether | | | 15 | 5 | 7.5 | 10 |
| elastomer | | | | | | |
| Carbon black | 50 | 50 | 50 | 50 | 49 | 48 |
| Zinc oxide | 3 | 3 | 3 | 3 | 3 | 3 |
| Stearic acid | 1.5 | 1.5 | 1.5 | 1.5 | 1.5 | 1.5 |
| Anti-aging agent | 3.25 | 3.25 | 3.25 | 3.25 | 3.25 | 3.25 |
| (S-13) | | | | | | |
| Wax | 1 | 1 | 1 | 1 | 1 | 1 |
| Oil | 12 | 12 | 12 | 12 | 12 | 12 |
| Sulfur | 1.54 | 1.54 | 1.54 | 1.54 | 1.54 | 1.54 |
| Vulcanization | 0.8 | 0.8 | 0.8 | 0.8 | 0.8 | 0.8 |
| accelerator (CZ) | | | | | | |
| Processability of | A | A | A | A | A | A |
| rubber composition | | | | | | |
| M100 | 100 | 152 | 134 | 180 | 168 | 160 |
| Elongation at break | 100 | 102 | 99 | 103 | 100 | 103 |
| tan δ (60° C.) | 100 | 113 | 95 | 100 | 99 | 98 |
| Permanent set | 100 | 135 | 124 | 110 | 108 | 103 |

TABLE 3

| Composition | | Comparative | | | | | |
|---|---|---|---|---|---|---|---|
| [component/compounded | Reference | Example | | | Example | | |
| amount (part by mass)] | Example | 5 | 6 | 7 | 7 | 8 | 9 |
| NR | 40 | 40 | 40 | 40 | 40 | 40 | 40 |
| BR | 60 | 60 | 60 | 60 | 60 | 60 | 60 |
| Acid-modified polyolefin 1 | | 30 | | 20 | 20 | 15 | 10 |
| Polyamide polyether elastomer | | | 30 | 20 | 10 | 15 | 20 |
| Carbon black | 50 | 50 | 50 | 50 | 48 | 49 | 50 |
| Zinc oxide | 3 | 3 | 3 | 3 | 3 | 3 | 3 |
| Stearic acid | 1.5 | 1.5 | 1.5 | 1.5 | 1.5 | 1.5 | 1.5 |
| Anti-aging agent (S-13) | 3.25 | 3.25 | 3.25 | 3.25 | 3.25 | 3.25 | 3.25 |
| Wax | 1 | 1 | 1 | 1 | 1 | 1 | 1 |
| Oil | 12 | 12 | 12 | 12 | 12 | 12 | 12 |
| Sulfur | 1.54 | 1.54 | 1.54 | 1.54 | 1.54 | 1.54 | 1.54 |
| Vulcanization accelerator (CZ) | 0.8 | 1.8 | 1.8 | 1.8 | 1.8 | 1.8 | 1.8 |
| Processability of rubber | A | A | A | B | A | A | A |
| composition | | | | | | | |
| M100 | 100 | 180 | 172 | — | 220 | 205 | 195 |
| Elongation at break | 100 | 101 | 102 | — | 98 | 98 | 102 |
| tan δ (60° C.) | 100 | 117 | 99 | — | 104 | 103 | 103 |
| Permanent set | 100 | 155 | 150 | — | 110 | 110 | 107 |

TABLE 4

| Composition | | | | | |
|---|---|---|---|---|---|
| [component/ | | | | | |
| compounded | | Comparative | | | |
| amount (part | Reference | Example | Example | | |
| by mass)] | Example | 8 | 10 | 11 | 12 |
| NR | 40 | 40 | 40 | 40 | 40 |
| BR | 60 | 60 | 60 | 60 | 60 |
| Acid-modified | | 15 | 10 | 7.5 | 5 |
| polyolefin 2 | | | | | |
| Polyamide | | | 5 | 7.5 | 10 |
| polyether | | | | | |
| elastomer | | | | | |
| Carbon black | 50 | 50 | 50 | 49 | 48 |
| Zinc oxide | 3 | 3 | 3 | 3 | 3 |
| Stearic acid | 1.5 | 1.5 | 1.5 | 1.5 | 1.5 |
| Anti-aging agent | 3.25 | 3.25 | 3.25 | 3.25 | 3.25 |
| (S-13) | | | | | |
| Wax | 1 | 1 | 1 | 1 | 1 |
| Oil | 12 | 12 | 12 | 12 | 12 |
| Sulfur | 1.54 | 1.54 | 1.54 | 1.54 | 1.54 |
| Vulcanization | 0.8 | 0.8 | 0.8 | 0.8 | 0.8 |
| accelerator (CZ) | | | | | |
| Processability | A | A | A | A | A |
| of rubber | | | | | |
| composition | | | | | |
| M100 | 100 | 140 | 185 | 178 | 158 |
| Elongation at | 100 | 95 | 102 | 103 | 108 |
| break | | | | | |
| tan δ (60° C.) | 100 | 121 | 100 | 100 | 97 |
| Permanent set | 100 | 134 | 108 | 104 | 102 |

Details of the components described in Tables 1 to 4 are as follows.
NR: Natural rubber, NUSIRA SIR20
BR: Butadiene rubber; Nipol BR1220, manufactured by Zeon Corporation; weight average molecular weight: 400000
Acid-modified polyolefin 1: Maleic anhydride-modified propylene polymer. A main chain is a homopolymer of propylene and is modified by maleic anhydride. The maleic anhydride is bonded to the main chain as a side chain. Admer QE060, manufactured by Sanyo Chemical Industries, Ltd.; melting point: 140° C.
Acid-modified polyolefin 2: Maleic anhydride-modified high density ethylene polymer. A main chain is a homopolymer of ethylene and is modified by maleic anhydride. The maleic anhydride is bonded to the main chain as a side chain. Admer HE810, manufactured by Sanyo Chemical Industries, Ltd.; melting point: 130° C.; density: 960 kg/m³
Polyamide polyether elastomer: UBESTA XPA P9040X1, manufactured by Ube Industries, Ltd.; melting point: 130° C.
Carbon black: Shoblack N550, manufactured by Showa Cabot K.K.; N₂SA: 42 m²/g; FEF
Zinc oxide: Zinc Oxide III, manufactured by Seido Chemical Industry Co., Ltd.
Stearic acid: Stearic acid, manufactured by Nippon Oil & Fats Co., Ltd.
Anti-aging agent (S-13): Antigen 6C, manufactured by Sumitomo Chemical Co., Ltd.
Wax: SANNOC, manufactured by Ouchi-Shinko Chemical Industrial Co., Ltd.
Oil: Extract No. 4S, manufactured by Showa Shell Sekiyu K.K.
Sulfur: Oil-treated sulfur, manufactured by Karuizawa Refinery Ltd.
Vulcanization accelerator (CZ): Sanceler CM-PO, manufactured by Sanshin Chemical Industry Co., Ltd.

As is clear from the results shown in Table 1 to Table 4, the rubber compositions which included polyamide polyether elastomer but did not include acid-modified polyolefin exhibited smaller elongation at break (Comparative Examples 2 and 4).

Furthermore, the rubber compositions which included polyamide polyether elastomer but did not include acid-modified polyolefin needed further enhancement in modulus (Comparative Examples 2, 4, and 6).

It was found that the cases where elongation at break was reduced (Comparative Examples 1 and 8) and the cases where low heat build-up was deteriorated (Comparative Examples 3, 5, and 8) were caused by the rubber compositions which included polyamide polyether elastomer but did not include acid-modified polyolefin.

Comparative Example 7 in which the total content of the polyamide polyether elastomer and the acid-modified polyolefin was greater than the predetermined range exhibited poor processability, and it was impossible to produce a rubber composition. Therefore, in Comparative Example 7, M100 and the like could not be evaluated, and the evaluation results for M100 and the like are shown as “-”.

Furthermore, a large amount of a polyamide polyether elastomer needs to be used to increase the modulus if the polyamide polyether elastomer alone is blended into the composition; however, it was found that the permanent set deteriorated when a large amount of the polyamide polyether elastomer was used (Comparative Examples 4 and 6).

Furthermore, although it is possible to increase the modulus by blending a large amount of an acid-modified polyolefin alone into the composition, it was found that the permanent set deteriorated when a large amount of the acid-modified polyolefin was used (Comparative Examples 3 and 5).

On the other hand, in Examples 1 to 12 of the present technology, an excellent modulus and processability and reduction in permanent set were achieved, while a high elongation at break and excellent low heat build-up were maintained.

Furthermore, in Examples 1 to 12 of the present technology, the modulus (M100) was enhanced while the compounded amount of the polyamide polyether elastomer was reduced, by using the polyamide polyether elastomer and the acid-modified polyolefin together.

Furthermore, it was found that the permanent set was reduced by using the polyamide polyether elastomer and the acid-modified polyolefin together (Examples 1 to 12).

From the results of Examples 1 to 12, it was also found that even higher modulus was achieved as the content of the acid-modified polyolefin was increased within the total content of the acid-modified polyolefin and the polyamide polyether elastomer.

When Examples 4 to 6 and Examples 10 to 12 are compared regarding the acid-modified polyolefin, it was found that the case where the acid-modified polyolefin 2 was used (Examples 10 to 12) further reduced the permanent set compared to the case where the acid-modified polyolefin 1 was used (Examples 4 to 6).

1. A rubber composition comprising:
a diene rubber;
at least one type selected from the group consisting of carbon black and a white filler;
an acid-modified polyolefin; and
a polyamide polyether elastomer;
a content of the at least one type selected from the group consisting of carbon black and a white filler being from 1 to 100 parts by mass per 100 parts by mass of the diene rubber, and
a total content of the acid-modified polyolefin and the polyamide polyether elastomer being from 3 to 35 parts by mass per 100 parts by mass of the diene rubber.

2. The rubber composition according to claim 1, wherein a content of the acid-modified polyolefin in the total content is from 2 to 30 parts by mass.

3. The rubber composition according to claim 1, wherein the rubber composition is obtained by mixing the diene rubber, the at least one type selected from the group consisting of carbon black and a white filler, the acid-modified polyolefin, and the polyamide polyether elastomer at a temperature equal to or higher than a melting point of the acid-modified polyolefin and equal to or higher than a melting point of the polyamide polyether elastomer.

4. A pneumatic tire comprising the rubber composition described in claim 1.

5. The rubber composition according to claim 2, wherein the rubber composition is obtained by mixing the diene rubber, the at least one type selected from the group consisting of carbon black and a white filler, the acid-modified polyolefin, and the polyamide polyether elastomer at a temperature equal to or higher than a melting point of the acid-modified polyolefin and equal to or higher than a melting point of the polyamide polyether elastomer.

6. A pneumatic tire comprising the rubber composition described in claim 5.
